(19) United States
(12) Patent Application Publication
(10) Pub. No.: US 2017/0235908 A1
(43) Pub. Date: Aug. 17, 2017

(54) Systems and Methods for Managing and Treating Substance Abuse Addiction

(71) Applicant: Tony Juneja, Lakewood, NJ (US)

(72) Inventor: Tony Juneja, Lakewood, NJ (US)

(73) Assignee: Oriah Behaviorial Health, Inc., Lakewood, NJ (US)

(21) Appl. No.: 15/352,144

(22) Filed: Nov. 15, 2016

Related U.S. Application Data
(60) Provisional application No. 62/255,504, filed on Nov. 15, 2015.

(51) Int. Cl. G06F 19/00

(52) U.S. Cl. CPC G06F 19/3418; G06F 19/322; G06F 19/345

(57) ABSTRACT

Systems and methods for providing substance abuse treatment and counseling to a remote user is provided. The system may include one or more remote servers; one or more remote terminals; wherein the remote terminals include at least one of a processor, a memory storage device, a camera capable of recording still frames, video, and streaming video, a microphone, a display device, and inputs for entering and recording text and biometric data; signal processing circuitry, an input buffer, and an output buffer; one or more communications links between the remote servers and the remote terminals; a computer readable medium on the one or more remote servers for processing, categorizing, and searching data stored within the remote servers; and a computer readable medium that calculates a value awarded as in incentive for storing biometric data on a remote server. The method may include prompting the user to provide values for attributes stored within a remote database; arranging and categorizing the data within the remote database in a hierarchical relationship; storing new patient data within in the remote database; creating a list of solved cases based upon the attribute values provided by the user; comparing the set of attributes in a new patient to the attributes of each case in the list of solved cases and removing any case from the list of solved cases that contains an attribute not within the set of attributes selected by the user; and presenting the list of candidate solved cases to the user.

### FIELD OF THE INVENTION

The present invention relates to computer systems and methods that implement remote patient care system for substance abuse care and treatment. More particularly, the systems and methods may care for and treat a patient by monitoring patient biometric data, patient lifestyle data, coursework data, quiz data, group interaction data, and data generated and extracted by using case-based reasoning.

### BACKGROUND OF THE INVENTION

Telemedicine applications (apps) that exchange health information from one location to another are well known in the art. In general health care, telemedicine is giving patients a sense that their illness is being monitored more closely, the ability to participate in their own health management, and a feeling they have not been forgotten by their doctor.

The addiction treatment field offers a promising setting for telemedicine use. The chronic nature of addiction disorders calls for methods for clinicians to stay connected with patients over extended periods of time. Face-to-face contacts between patients and clinicians are limited to scheduled appointments or group sessions. Counselors are not available when they're most needed: outside the treatment setting, where patients make decisions to stay sober or not. Telemedicine extends the providers' availability and offers patients an immediate resource.

Telemedicine may increase access to addiction treatment service by removing the barriers of geography and stigma. Patients in rural areas who in the past had to drive long distances can now receive addiction services within their own homes. Through telemedicine, patients can also avoid experiencing the perceived stigma of being identified as a patient at a specialty addiction treatment provider. In practice, a variety of electronic systems and methods are increasing the use of telemedicine in addiction treatment and recovery. The most mature modality, telephone-based care, has been used to provide continuing care for substance use disorders (SUDs). Continuing care delivered by telephone is easy to implement and does not carry additional costs such as licensing fees or patient training. Telephone-based services have included telephone monitoring, feedback, and counseling. Study results for telephone-based continuing care are mixed, but generally show better results than traditional continuing care.

An enhanced application of telephone-based technology is interactive voice recognition (IVR) technology. In IVR, an automated telephone system provides patients with different follow-up and feedback options based on their responses to pre-established questions. This technology has been tested in primary care settings with mixed therapeutic results. IVR tested in pilot studies in specialty treatment settings reduced post-outpatient treatment drinking days per week, but only for patients who had achieved treatment goals at time of discharge.

Web-based telemedicine services are accessible to many patients and are typically “asynchronous,” meaning that people can access them any time, at their convenience. Several web-based platforms and apps for SUD assessment are available. Overall, web-based telemedicine services have been found to be more effective at reducing substance abuse. For example, web-based alcohol screening, assessment, and feedback or brief intervention, the Drinker's Check-up (DCU) has demonstrated positive results in several clinical trials. The DCU (www.drinkerscheckup.com) is an integrated computerized system that includes Moderate Drinking (moderatedrinking.com), a web app for people who want to reduce their drinking, along with several other components: 1) a brief screening that utilizes the Alcohol Use Disorders Identification Test (AUDIT); 2) an in-depth assessment; 3) a full motivational session tailored to the individual's assessment results; and 4) computerized cognitive treatment options that link to web-based mutual aid groups. Similarly, web-based, computerized, brief interventions for drug use demonstrate results similar to or better than clinician-delivered services.

An example of a web-based SUD treatment is the Therapeutic Education System (TES). TES consists of 65 modules based on the Community Reinforcement Approach (CRA) and includes modules on HIV/STD prevention. TES is provided in conjunction with clinician-delivered services and serves as a clinician extender. Research studies are demonstrating superior outcomes for patients using TES compared to treatment as usual. Research studies are also showing TES results comparable to those for the CRA delivered in person by highly trained clinicians.

Another web-based treatment approach that has been examined in research studies is Computer-Based Treatment for Cognitive Behavioral Therapy (CBT4CBT). Research studies have shown positive outcomes (similar to the TES studies) with CBT4CBT compared to treatment as usual or treatment provided solely by clinicians.

Still another treatment approach is videoconferencing for addiction treatment or psychiatry occurs through secure portals on personal computers or dedicated telemedicine consoles. Videoconferencing is currently used in addiction services for: 1) video therapy, where patients can interact with clinicians from a remote location or the privacy of their homes; 2) recovery supports, where a counselor or peer-support specialist interacts with a person in recovery; and 3) specialty services, where patients are placed in contact with hard-to-reach medical specialists, such as an adolescent psychiatrist or a physician who can prescribe buprenorphine for opioid addiction. Studies in videoconferencing for addiction services have found no difference in the results or patient satisfaction of care provided in person or by video.

Yet still another treatment approach is to utilize mobile devices such as, for example, smartphones, tablets, etc. Mobile devices make substance abuse treatment and recovery support available 24 hours a day, 7 days a week. An early analysis of mobile device use in overall health care determined that it is too early to pool effects of this technology, and that the positive effects that have been realized are primarily attributed to texting interventions within the mobile device apps. Smartphones, tablets, and the like offer the same services as telephone-based, web-based, and videoconferencing services.

Accordingly, what is needed are systems and methods that incorporate the advantages of inpatient treatment while the patient is in a home or private environment.

Additionally, what is needed are systems and methods that incorporate the use of biometric data, pictorial data, voice data, blood chemistry data, sleep data, urinalysis data, genetic data in order to care for a patient and to form a care and treatment plan on based upon such data.

Further, what is needed are systems and methods that incorporate more traditional forms of patient care and treatment such as coursework, counseling, medications, and testing to form a treatment plan on based upon such data incorporated in a telemedicine platform.

Still further, what is needed are systems and methods for comparing patient data to data of similarly situated different patents to care for and form treatment plan for a patient in a telemedicine platform.

Yet still further, what is needed are systems and method that create an incentive systems and methods for patents to follow the prescribed care and treatment plans in a telemedicine platform.

### SUMMARY OF THE INVENTION

The present invention is a computer system involving both software, hardware, and one or more other peripheral systems to acquire patient data and display such data, including but not limited to journals, logs, coursework, and biometric data. The systems and methods of the present invention may also include and incentive systems and methods to incentivize individuals to utilize all of the features of the present invention.

The system and methods of the present invention may include one or more local or remotely connected servers, computers, and terminals. These terminals may include Patient Assistant Terminals (PATs) and/or Patient Care Terminals (PCT). These terminals may be connected to the one or more servers and computers via any wireless or wired LAN system(s), telephone communication networks, satellite networks, cable television networks, and/or any other suitable communications network.

The present invention may include peripheral equipment. Such equipment may include biometric systems to read and input height, weight, temperature, blood pressure, oxygen saturation, blood chemistry, organ function, voice data, pictorial data, sleep data, urinalysis data, genetic data, and any other data that may be used to monitor the health and well-being of a patient. Other input devices such as may be cameras, video and voice recorders, keyboards, mouse, touch screens and the like may be used to input data into the present invention. Other peripheral equipment may include graphic display devices, speakers, printers and any other output devices for a user to view and hear patient data.

Moreover, the present invention may include one or more local or distributed memory storage devices to store patient data including biometric data, pictorial data, voice data, blood chemistry data, sleep data, urinalysis data, genetic data, cameras, video and voice recorders, coursework, counseling, medications, and coursework testing and the like in order to care for a patient and to form a treatment plan on based upon such data.

The computer system may utilize Electronic Medical Record (EMR) data, which is a collection of electronically stored health information in a digital format in order to provide one or more physicians and/or care givers the necessary information in a secure/encrypted format to care for and treat a patient to authorized personnel.

Patient care and treatment may be based upon the following: 1) current patient data (same day or real-time streaming data), 2) comparisons to historical data from the present patient, 3) historical data from a population of similarly situated patients with similar biometric data and symptoms using case based reasoning, 4) patient biometric data and data from patient input.

For Example U.S. Pat. No. 5,822,743, comprises a database of solved cases and a reasoning engine to extract relevant cases from a database. One of the key advantages of case-based reasoning systems is that they provide a repository of knowledge that has been distilled from historical records or occurrences on how to solve problems, which is far greater than that which could be expected to reside in an individual physician or even several physicians who work together. Accordingly, patient care may be provided by one or more physicians and staff working in collaboration to effectively care for and treat a patient.

The one or more physicians and staff may acquire patient data (e.g., EMR data, biometric data, journal data, log data, coursework data, etc.) by accessing the patient entered data locally or remotely using any communication protocol such as hypertext markup language, TCP, TCP/IP, Ethernet, Token Ring, FTP to receive and/or transmit information to and from the local or remote servers. It is understood that not every transmission protocol is set forth herein but it is understood that such communication protocols are within the spirit and scope of the present invention.

Additionally, the systems and methods of the present invention may include a messaging system for physician to patient, patient to physician, physician to staff, staff to physician, and physician to physician communication. In order to communicate instructions to the receiving party. All communications are recorded within the present invention's memory for audit and training purposes.

When data is entered by a user of the present invention the database automatically incorporates the new information into the patient profile so that all care givers have the most up-to-date information on the patent to ensure the best possible care. Specifically, the central server with one or more processors coordinate the communication with peripheral input and output devices in addition to assigning and granting the associated permissions for access to the patient data.

In another aspect of the present invention, the invention may include systems and method that create an incentive for patents to follow the prescribed care and treatment plans. An illustrative example may include where the user may accumulate points redeemable for items that the user may desire. Such point may be accumulated for watching videos, participating in group sessions, taking and passing quizzes on the assigned coursework, monitoring and performing diagnostic biometrics, such as, for example, regularly testing instantaneous glucose, A1C testing, lipid testing, performing a urinalysis, having blood chemistry taken, performing oxygen saturation, inputting diet information and caloric intake, etc. Embodiments of the present invention miniaturize and consolidate medical diagnostic electronic circuitry with additional software and hardware circuits that provide motivational elements before, during and after the diagnostic testing procedure. All of the aforementioned testing would have circuitry incorporated within or as an attachment module to the Patient Assistant Terminals (PATs) and/or Patient Care Terminals (PCT) would may be designed into a physical form that allows said medical circuits to be physically inserted into a socially acceptable hand-held microprocessor driven controller.

As described above, Patient Assistant Terminals (PATs) and/or Patient Care Terminals (PCT) may have their own electronic identification code, connecting to the local and/or remote server computer(s) by any communication protocol as mentioned supra. The PATs and the PCTs may include graphic display devices, showing graphic representations of the biometric data to be collected. Additionally, the PCTs and EAT's may include text menu items, which are loaded from the local and/or remote server(s)for the viewing of videos, performing coursework, and the administration of quizzes on the coursework material. Additionally, the PCTs and PATs and the PCTs may be electrically linked to any type of peripheral input device for capturing biometric data. The PCTs and PATs are low power devices and may be powered by rechargeable battery.

Another aspect of the present invention includes systems and methods for combining a medical device diagnostic system, a medical testing procedure, in a combination of hardware and software that provide motivation and digital rewards through a remote terminal.

In view of the potential commercial availability of these types of devices, the embodiments of the invention miniaturize and consolidate medical diagnostic electronic circuitry with additional software and hardware circuits that provide motivational elements before, during and after the diagnostic testing procedure. Such medical diagnostic electronic circuits are those that perform tests for blood glucose, high blood pressure, lipids, peak and flow, oxygen saturation, and any other biometric data.

After biometric data is converted and proper readings are displayed via a video display device on the user device and/or stored, a user of the device can select from a menu of different commands generated by the motivational hardware/software structure of the invention. Such motivation incentives would be intended to educate and encourage more frequent participation in testing and of biometric data on a frequent basis. The rewards serve as a root motivation for the user to perform frequent testing and recording of biometric data. According to another aspect of the invention, the hardware/software stores the biometric values to an EEPROM that can be retrieved at a later date.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a generalized block diagram of a system for implementing remote patient care for substance abuse care and treatment in accordance with one embodiment of the present invention;

FIG. 2 is a schematic diagram of circuitry constructed in accordance with one possible embodiment of the present invention;

FIG. 3 shows a terminal and computer and/or server based implementation remote patient care for substance abuse care and treatment in accordance with one embodiment of the present invention;

FIG. 4 shows communications embodiments for implementing remote patient care for substance abuse care and treatment in accordance with one embodiment of the present invention;

FIG. 5 shows illustrative patient data that may by input into the present invention;

FIG. 6 show a flow chart illustrating some of the steps involved in using preexisting patient data to solve for a new case in accordance with one embodiment of the present invention;

FIG. 7 show a flow chart illustrating some of the steps involved in using preexisting patient data to solve for a new case in accordance with one embodiment of the present invention;

FIG. 8 shows a flow chart illustrating some of the steps involved in motivational and incentive system and method in accordance with one embodiment of the present invention.

### DETAILED DESCRIPTION OF THE PREFERRED EMBODIMENT

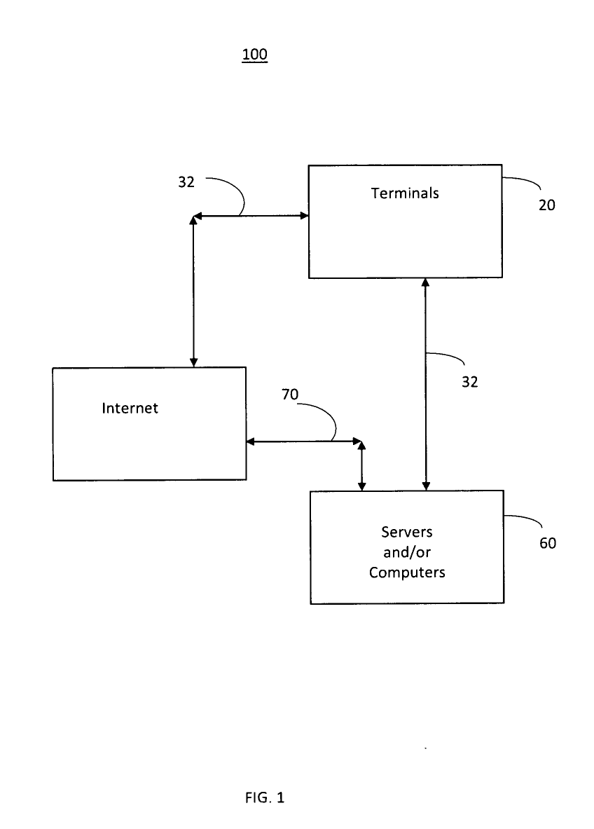

FIG. 1 shows a block diagram of a System 10 for system and methods of the present invention that may include one or more local or remotely connected servers and/or computers 60, and Terminals 20. These terminals may include Patient Assistant Terminals (PATs) and/or Patient Care Terminals (PCT). These terminals may be connected to the one or more servers and computers via any wireless or wired LAN system(s), telephone communication networks, satellite networks, cable television networks, TCP/IP to the Internet and/or any other suitable communications network 32. programming user-defined information (e.g., audio, video, or Internet access information, etc.) into an electronic device in accordance with one embodiment of the present invention. As shown in FIG. 1, system 10 generally includes a Terminals 20 and a computers and/or servers 60. Terminals 20 and a computers and/or servers 60 may be connected to directly to computers and/or source 60 via links 32 and or 70 using the illustrative example above or by any other suitable communications protocol.

Terminals 20 may be any portable electronic device (e.g., a wireless telephone, a pager, a handheld computer, personal digital assistant (PDA), etc.). Terminals 20 may also be any device which integrates some or all of the functions of such devices into one device. For example, Terminals 20 may be a PDA capable of making wireless telephone calls, a PDA with paging functions, a wireless telephone with some PDA or paging functions, a handheld or notebook computer with some or all of the functions of a PDA, a pager, and a telephone, etc.

In FIG. 1, links 32 and 70 may also include, for example, communications links (e.g., serial ports, parallel ports, universal serial buses (USB), RS232, GPIB, etc.), modems (e.g., any suitable analog or digital modems, cellular modems, or cable modems), a network interface link (e.g., Ethernet links, token ring links, etc.), wireless communications links (e.g., cellular telephone links, wireless Internet links, infrared links, satellite links, etc.), or any other suitable hard-wired or wireless Internet or communications links.

Terminals 20 may include any device or combination of devices suitable for capturing, viewing, and transmitting biometric data; capturing, viewing, and transmitting voice and/or video data; capturing, viewing, and transmitting graphical or text information, etc. (e.g., a heart rate monitor, a drug screen device, a breathalyzer, an oxygen saturation meter, a thermometer, an EKG/EEG monitor, a fitness monitor, a sleep pattern monitor, a glucose monitor, and A1C monitor, a blood chemistry analyzer, a urinalysis monitor, or any other detector to monitor a patients physical health and well being).

In operation, a user may choose certain information, such as Internet configuration information on Terminals 20. servers and/or computers 60 may also coordinate or perform certain functions related to the routing and storing of information received from Terminals 20. For example, Terminals 20 may communicate with computers and or servers 60 to find available memory locations in which to store the user-defined information. Terminals 20 may also communicate with computer and/or servers 60 to determine which protocol in which the incoming information should be converted to so that the information is compatible with the downloading requirements of Terminals 20. For audio and video files, this may include, but is not limited to, converting to or from any of the following format types: analog; MIDI; MPEG; PCM; Windows Media Audio Code (WMA); WAV; or Adaptive Transform Acoustic Coding (ATRAC), or to or from any other suitable audio format, etc. For video files, this may include, but is not limited to, converting to or from any of the following format types: analog; JPEG; MPEG; GIF; AVI, JPEG 2000; MOV; QuickTime; or to or from any other suitable video format, etc. Text files may include, for example, HTML files, Wireless Markup Language (WML) files, WordPerfect™ files, Microsoft Office™ files, or any other suitable text files. If multiple blocks of information are being sent to or transmitted from Terminals 20, computer and/or servers 60 may “tag” the different blocks so that terminals 20 may distinguish among the different blocks stored therein. After the information has been provided, terminals 30 and/or computers and/or servers 60 may communicate with each other to confirm that the information has been correctly received.

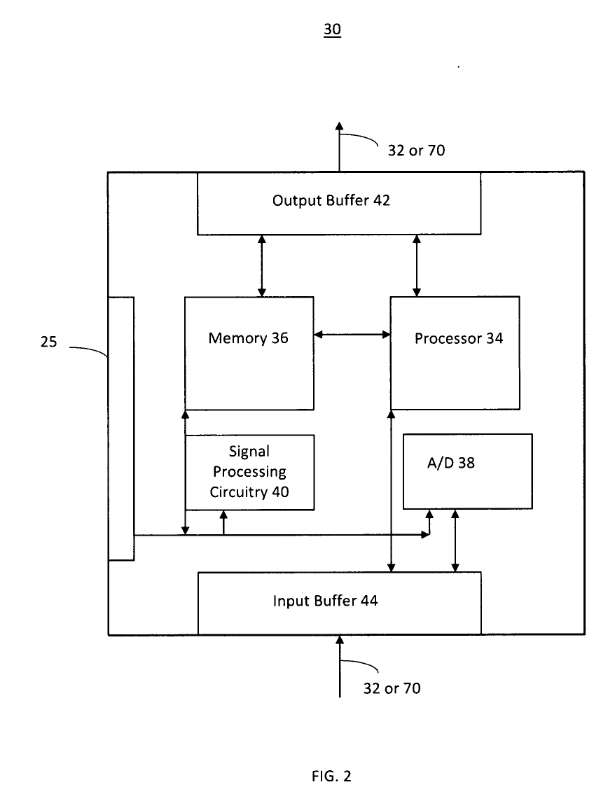

A more detailed diagram of one possible embodiment of the circuitry contained within Terminals 20 and/or computers and/or servers 60 is illustrated in FIG. 2. As illustrated, Terminals 20 and/or computers and/or servers 60 may include a transducer 25, one or more processors 34, one or more programmable memory 36, an analog-to-digital (ND) converter 38, signal processing circuitry (SPC) 40, an output buffer 42, and an input buffer 44. Generally speaking, processor 40 controls the operation of programmer 30. Programmer 30 may be configured to receive and process both analog and digital signals. It may also acquire acoustic signals via transducer 25 (if installed).

In operation, Terminals 20 may download certain user-selected information from computers and/or servers 60 via links 32 and/or 70. This information, such as audio or video files, in the form of electronic signals, may be received from link 32 and/or 70 and directed to input buffer 44. As mentioned above, these signals may need to be processed in order to be compatible with the format required by Terminals 20. For example, if analog input signals are received at input buffer 44 and device 20 requires a digital format, the analog signals may be routed to A/D converter 38 for conversion into a suitable digital form (e.g., into PCM, PAM, etc.). Further processing into another digital format (e.g., MP3, ATRAC, WMA, etc.) may be accomplished by routing the converted signals to SPC 40 or processor 34 (discussed in more detail below). On the other hand, if digital input signals are received at input buffer 44 and device 20 requires analog signals, the digital signals may be routed to SPC 40 or to a dedicated digital-to-analog (D/A) converter (not shown) for conversion to the analog domain.

Processor 34 may route incoming signals from Terminals 20 and/or from computers and/or servers 60 to memory 36, SPC 40, or directly to output buffer 42 depending on the circumstances. For example, some or all of the input signals received from Terminals 20 and/or from computers and/or servers 60 may require further processing to meet the downloading specifications of Terminals 20. In this case, the incoming signals that require processing may be routed to SPC 40 for such processing. For example, incoming MP3 or WMA signals may be routed to SPC 40 and converted to ATRAC format (or vice-versa). Once this conversion is complete, the resulting information may be stored in memory 36, or routed to output buffer 42 for usage in Terminals 20. Input signals that do not require a format change may be routed directly from input buffer 44 to memory 36, or output buffer 42. Although not shown in FIG. 2, Terminals 20 preferably has a display screen and a data input device, such as a keyboard associated with it so that a user may, among other things, browse and select files, monitor file transfers, view videos, answer testing information, and ensure that Terminals 20 has properly received the selected files.

In one embodiment of the present invention, SPC 40 may be programmable so that the conversion and processing protocols contained therein may be periodically updated. Furthermore, in some embodiments, processor 34 may be programmed via software routines in programmable memory 36 to perform some or all of the functions of SPC 40. In this case, an SPC of reduced processing capacity may be used or SPC 40 may be removed altogether from Terminals 20.

Audio, video, and biometric signals may also be acquired and processed by Transducer 23. Transducer 25 may acquire data signals and convert such signals into an electrical signal. This electrical signal may then be processed in a way similar to the way the above-described analog signal was processed. That is, the electrical signal may be routed to A/D converter 38 and/or SPC 40 and then stored in memory 36 or output buffer 42, for example.

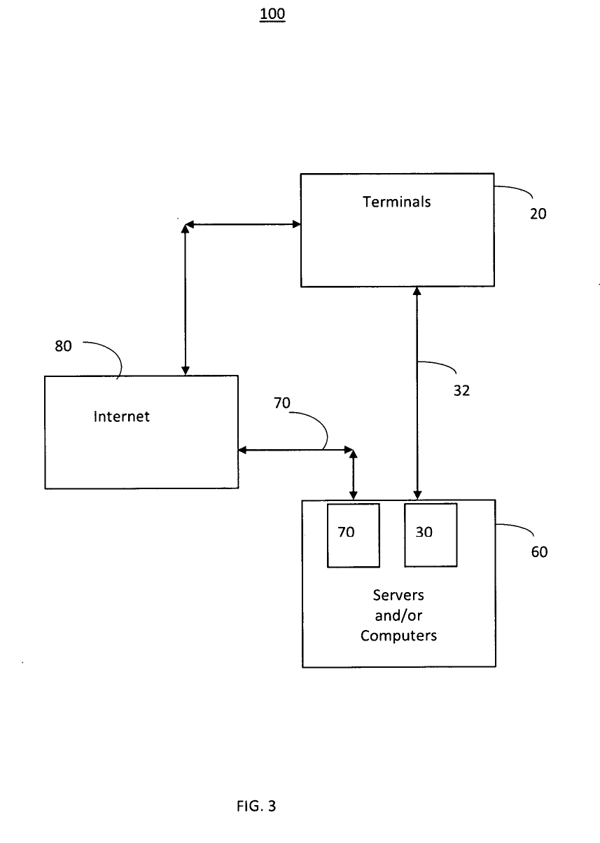

It will be understood that the generalized system shown in FIG. 1 may be implemented in many ways. For example, as shown in FIG. 3, system 100 may be implemented using a computer-based architecture. In this case, some or all of the processing circuitry installed within Terminals 20 and/or computers and/or servers 60 may be installed in or connected in an expansion slot and connected to an interface bus such as an ISA or PCI bus (not shown). In this configuration, Terminals 20 and/or computers and/or servers 60 may receive information via the interface bus located within Terminals 20 and/or computers and/or servers 60. Furthermore, in certain embodiments, some of the functions of Terminals 20 and/or computers and/or servers 60 may be distributed between Terminals 20 and/or computers and/or servers 60. For example, Terminals 20 may be constructed such that it partially or fully relies on the processing capability of computer and/or servers 60. In this type of embodiment, Terminals 20 may be constructed without processor 34 or with a processor of reduced capacity. Moreover, signal processing functions such as those performed by SPC 40 could also be fully or partially carried out by circuitry or software resident within computer and/or servers 60.

As shown in FIG. 3, computer and/or servers 60 may be connected to Internet 80 through link 70. Link 70 may be, for example, a modem (e.g., any suitable analog or digital modem, cellular modem, or cable modem), a network interface link (e.g., an Ethernet link, token ring link, etc.), a wireless communications link (e.g., a wireless telephone link, a wireless Internet link, an infrared link, etc.), or any other suitable hard-wired or wireless communications link. With this configuration, a user may download information from Internet 80 (e.g., using electronic distribution (ED) services) and/or from a disc drive or other devices (not shown) connected to computer and/or servers 60 and program that information into Terminals 20 (via link 32).

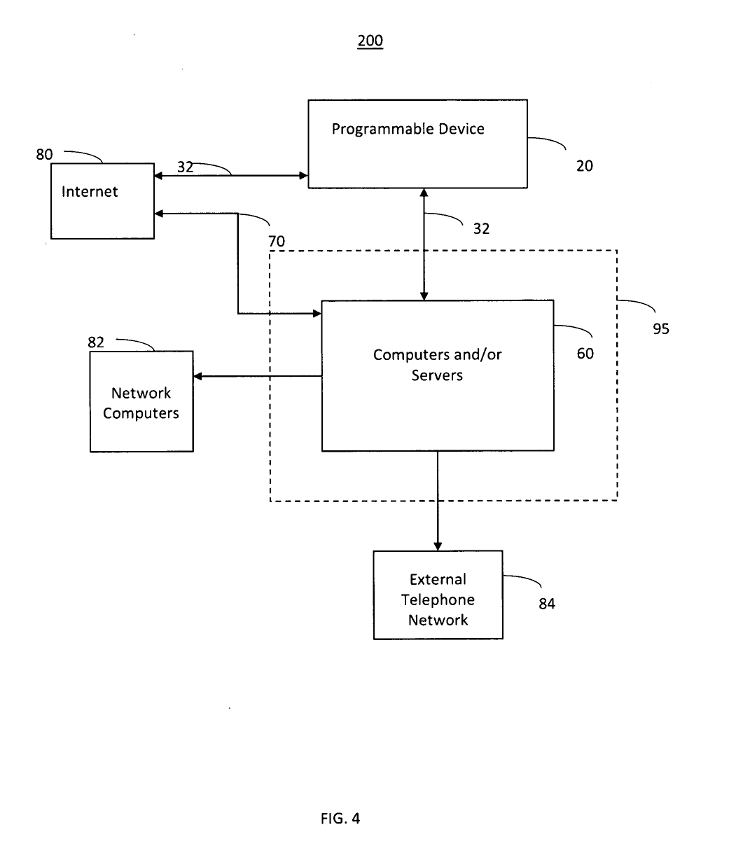

As shown in FIG. 4, computer and/or servers 60, may be connected to Internet 80 through link 70 and to Terminals 20 through link 32. This arrangement allows a user to select information from Internet 80 and/or from a storage devices connected to computers and/or servers 60 for programming into Terminals 20.

Using the generalized system shown in FIG. 1, information may be captured, processed, stored, and transmitted from Terminals 20 in many ways. For example, computer and/or servers 60 may be part of a communications network 95, such as a telephone network, that provides Internet and/or telephone access to Terminals 20. Communications network 95 may provide hard-wired or wireless telephone, Internet access (or combination of the two), or any other suitable communication system to transmit and receive data and electronic signals. With this configuration, a Terminals 20 may access Internet 80 and select information for downloading into Terminals 20.

In operation, computer and/or servers 60 may communicate with terminals 20 to determine the proper format requirements and perform any conversions necessary to make desired information compatible with those requirements. This allows a user to select information, such as Text, audio and/or video, that is available on the Internet or on a remote network computer, and program that information into Terminals 20. This may be accomplished via communications link 32 (which may be any type of link previously described). For example, a user may wish to download video images from an Internet site to a hand-held computer, such as a PDA, or to a wireless telephone. The user may communicate with computer and/or servers 60 via link 32 and select information from Internet 80 using an Internet browser installed in Terminals 20. Such a browser may be a Wireless Application Protocol (WAP) compliant browser for supporting wireless Internet services. Computer and/or servers 60 ensures format compatibility of the information, transmits the information to Terminals 20, and may communicate with Terminals 20 to confirm that the selected information has been properly received. Terminals 20 may provide a visual, audio, or tactile output to indicate the requested information has been successfully received.

Computer and/or servers 60 may coordinate information downloading with respect to the memory capacity of Terminals 20. For example, if the user-selected information exceeds the available memory of Terminals 20, computer and/or servers 60 may inform the user, via link 32, that the selected information is larger than the available memory. in such an event, the user may be prompted to cancel or modify the information request. In certain instances, however, the user may instruct computer and/or servers 60 to provide the information in a “scrolling” fashion (i.e., provide it in portions) so that all the requested information may be reviewed, albeit in sections. This may be particularly desirable in instances where large files, such as video files, are requested.

In some embodiments of the present invention, computer and/or servers 60 may simply contact a remote computer or Internet site to fulfill requests for audio or video information in a particular format. Such web sites or remote computers may act as virtual “database” of video and audio information, containing extensive lists of such information in a variety of formats available for downloading. Using this approach, a user may select a particular piece of information in a certain format from a list displayed on a screen of Terminals 20. Computer and/or servers 60 may receive this as a request via links 32 and/or 70 and handle the information transfer to Terminals 20. In some embodiments, format selection may be transparent to the user. That is, the user may simply request a piece of information and computer and/or servers 60 may determine and then request information in a format appropriate for the requesting device.

In another embodiment, a remote computer or Internet site may perform a format conversion of information requested by computer and/or servers 60 or Terminals 20. For example, a user may access an Internet site or remote computer using communications network 95 and enter a title or description of the desired audio or video information along with format requirements. The remote computer or Internet site may then search the Internet or other databases to find a file that matches the user's description. Once this file is found, the Internet site or remote computer may convert that file to the requested format, (using a system similar to the described above) and provide it to Terminals 20 via computer and/or servers 60 and/or links 32 and/or 70. It will be understood, of course, that embodiments such as these are within the scope of the present invention.

If desired, a user may also employ the systems shown in FIG. 4 to download remotely stored information such as Internet access and local and/or remote database information to Terminals 20. For example, a user may have customized bookmarks or web page addresses stored in a remote personal computer or on Internet 80. The user may employ wireless link 32 or 70 to contact that remote computer or Internet site and then download the Internet access information for use in Terminals 20. This feature is desirable because it relieves the user of the burden of having to type in complicated Internet access information from the small keyboard of a wireless telephone or hand-held computer. It also spares the user from having to re-enter customized Internet information that is already present in another location, into their electronic device. Moreover, such a feature is convenient when a user wishes to access information on a remote computer that is not currently available in Terminals 20. For example, a user may wish to view information stored on a remote computer with device 20. Rather than having to download this information form a hard-wired access point, a user may simply employ wireless link 32 (e.g., a wireless modem or Internet connection) to access that remote computer or Internet site and download that information to Terminals 20.

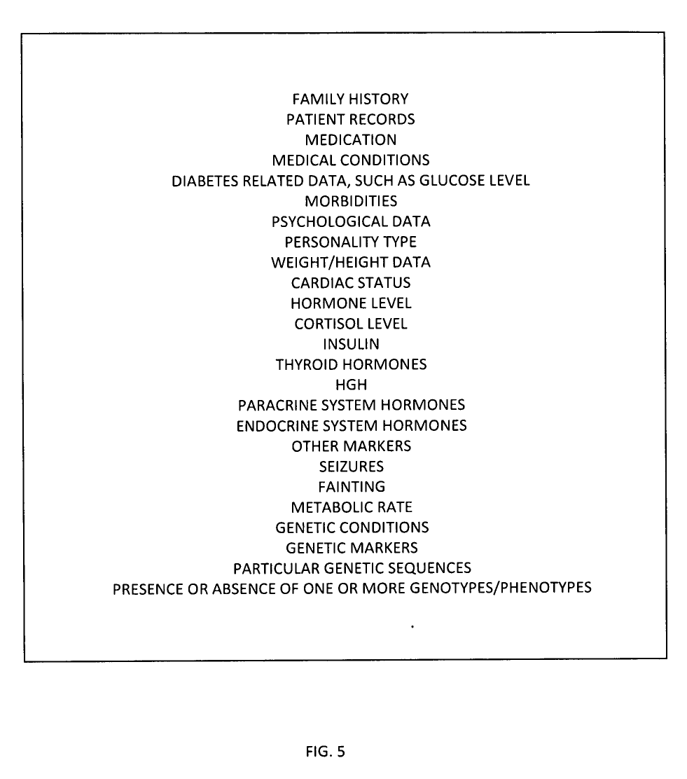

FIG. 5 is of possible patient information that may be acquired for user input, sensor data, laboratory testing, and the like for use in the treatment of a patient. Persons skilled in the art will appreciate that this enumerated list of patient data is only a partial list for illustrative purposes and that the present invention can be practiced by other than the described embodiments.

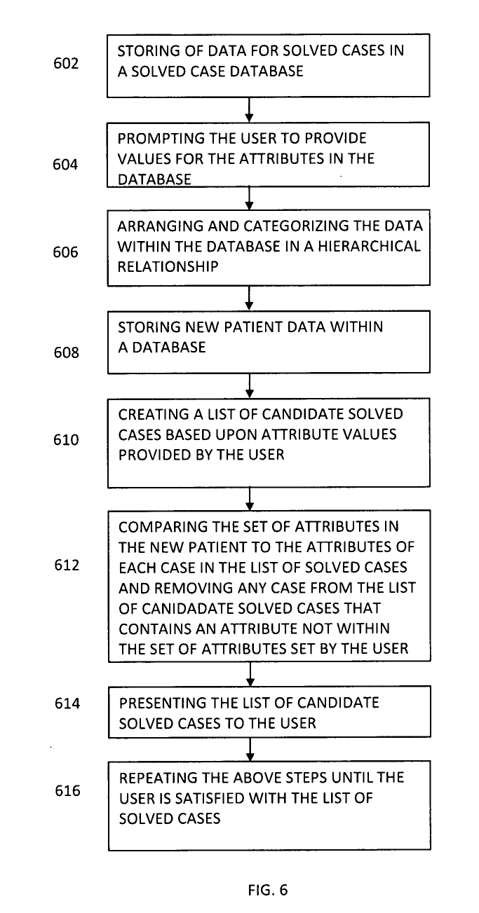

As shown in FIG. 6, the present invention may be directed to systems and methods for assisting a doctor in solving a new problem case for a specific patient using data from similarly situated patients with similar biometric and other data, comprising the steps of: Storing data for solved cases in a solved case database as shown in step 602; prompting the user to provide values for the attributes in the database in step 604; arranging and categorizing the data within the database in a hierarchical relationship in step 606; storing new patient data within in a database in step 608; creating a list of candidate solved cases based upon the attribute values provided by the user in step 610; comparing the set of attributes in the new patient to the attributes of each case in the list of solved cases and removing any case from the list of candidate solved cases that contains an attribute not within the set of attributes selected by the user in step 612; presenting the list of candidate solved cases to the user in step 614; repeating the above steps until the user is satisfied with the list of solved cases in step 616.

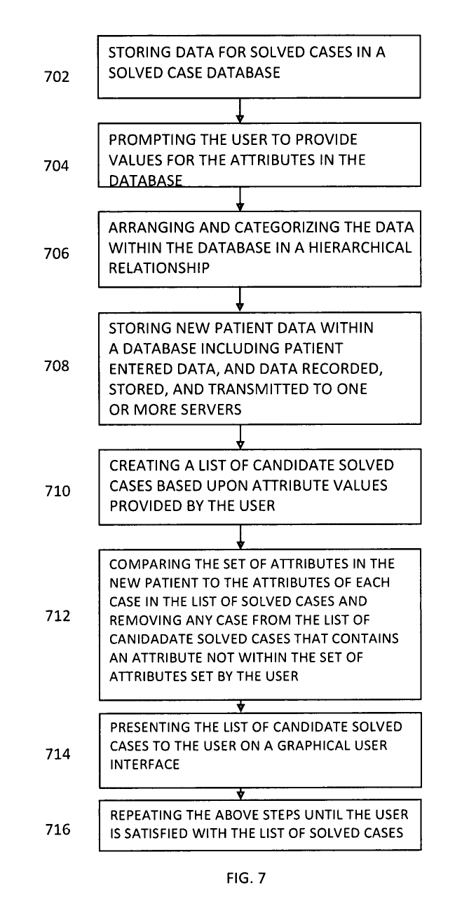

As shown in FIG. 7, the present invention may be directed to systems and methods for assisting a doctor in solving a new problem case for a specific patient using data from similarly situated patients with similar biometric and other data, comprising the steps of: Storing data for solved cases in a solved case database as shown in step 702; Prompting the user to provide values for the attributes in the database in step 704; Arranging and categorizing the data within the database in a hierarchical relationship in step 706; storing new patient data within in a database including biometric data and recorded data stored and transmitted to one or more servers in step 708; creating a list of candidate solved cases based upon the attribute values provided by the user in step 710; comparing the set of attributes in the new patient to the attributes of each case in the list of solved cases and removing any case from the list of candidate solved cases that contains an attribute not within the set of attributes selected by the user in step 712; presenting the list of candidate solved cases to the user in a graphical user interface in step 714; repeating the above steps until the user is satisfied with the list of solved cases in step 716.

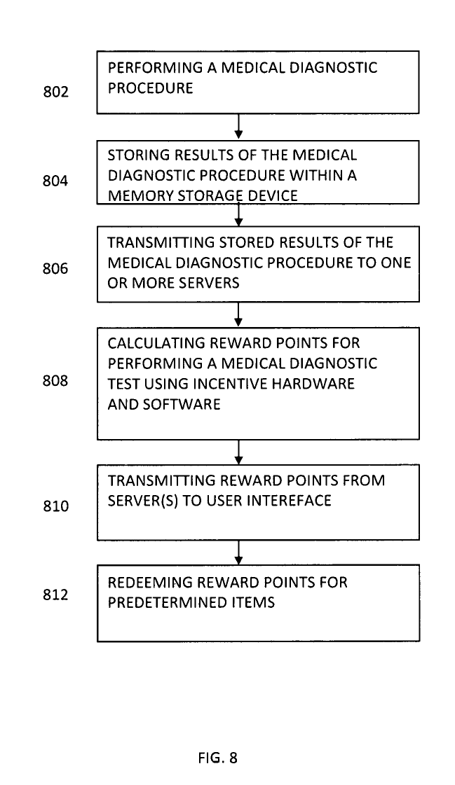

As shown in FIG. 8, the present invention may be directed to systems and methods for providing incentives to users to perform testing and coursework as part of a treatment plan. The present invention may include: Performing a medical diagnostic procedure as shown in step 802; Storing results of the medical diagnostic procedure within a memory storage device as shown in step 804; Transmitting stored results of the medical diagnostic procedure to one or more servers as shown in step 806; Calculating reward points for performing a medical diagnostic test using incentive hardware and software as shown in step 808; Transmitting rewards points from server(s) to a user interface as shown in step 810; and Redeeming reward points for predetermined items as shown in step 812.

It should be noted that different types of sensors and applications m usable according to embodiments of the invention include: photo-electrics for sensing heart rate, blood sensing, height sensing; piezo-resistive for strength measurement, weight measurement, heartbeat detection, lung capacity measurement; pressure for measuring lung capacity, blood pressure, and pressure-based scalpel; mass air flow sensing for determining lung capacity; fiber optic sensors for measuring measurement or viewing the inner ear; thermocouple sensing for measuring body temperatures; carbon dioxide and oxygen sensors, moisture sensors for performing sweat analysis and moisture detection, glucose monitoring, as described herein, and ultrasonic sensors for profiling bone structure and height measurement.

Persons skilled in the art will appreciate that this enumerated list of patient data is only a partial list for illustrative purposes and that the present invention can be practiced by other than the described embodiments, which are presented for purposes of illustration rather than of limitation, and the present invention is limited only by the claims which follow.

What is claimed is:

1. A method of providing substance abuse treatment and counseling to a remote patient, the method comprising:
a. prompting the user to provide values for attributes stored within a remote database;
b. arranging and categorizing the data within the remote database in a hierarchical relationship;
c. storing new patient data within in the remote database;
d. creating a list of solved cases based upon the attribute values provided by the user;
e. comparing the set of attributes in a new patient to the attributes of each case in the list of solved cases and removing any case from the list of solved cases that contains an attribute not within the set of attributes selected by the user; and
f. presenting the list of candidate solved cases to the user.

2. The method of claim 1, wherein the arranging and categorizing the data within the remote database in a hierarchical relationship comprises assigning values and weights to the data stored within the remote database.

3. The method of claim 1, wherein the prompting the user to provide values for attributes stored within a remote database, such attributes are at least one of biometric attributes, recorded attributes, and answers to questions from person treating the user.

4. The method of claim 3, wherein the biometric attributes comprise a plurality of heart rate information, drug screen information, breathalyzer information, oxygen saturation information, temperature information, EKG/EEG information, fitness information, sleep pattern information, glucose information, A1C information, other blood chemistry information, and urinalysis information.

5. The method of claim 4, further comprising storing user attributes within a remote server in a digital format of the group consisting of: TIFF, JPEG, JPEG 2000, GIF, PNG, AVI, ASF, MOV, QT, AVCHD, FLV, and Raw image files.

6. A system that provides a substance abuse counseling program to a remote user, the system comprising:
a. one or more remote servers;
b. one or more remote terminals; wherein the remote terminals include at least one of a processor, a memory storage device, a camera, a video recording device, a streaming camera, a microphone, a display device, and inputs for entering and recording text and biometric data;
c. one or more communications links between the remote servers and the remote terminals; and
d. a computer readable medium on the one or more remote servers for processing, categorizing, and searching data stored within the remote servers.

7. The system of claim 6, further comprising a computer readable medium that calculates a numerical value awarded as in incentive for storing biometric data on a remote server.

8. The system of claim 7, further comprising an analog to digital converter for acquiring analog biometric signals and converting them into digital signals.

9. A system that provides a substance abuse counseling program to a remote user, the system comprising:
e. one or more remote servers;
f. one or more remote terminals; wherein the remote terminals include at least one of a processor, a memory storage device, a camera capable of recording still frames, video, and streaming video, a microphone, a display device, and inputs for entering and recording text and biometric data; signal processing circuitry, an input buffer, and an output buffer;
g. one or more communications links between the remote servers and the remote terminals;
h. a computer readable medium on the one or more remote servers for processing, categorizing, and searching data stored within the remote servers;
i. a computer readable medium that calculates a value awarded as in incentive for storing biometric data on a remote server.

10. The system of claim 1, wherein the remote terminals that include inputs for entering and recording text and biometric data, signal processing circuitry, an input buffer, and an output buffer; wherein the biometric data is acquired from biometric sensors that are coupled to the human body.

11. The system of claim 10, wherein the biometric sensors include photo-electrics sensors, blood chemistry sensors, laser sensors; piezo-resistive, weight sensors, blood pressure sensors, pressure-based sensors; mass air flow sensors; fiber optic sensors, thermocouple sensors; carbon dioxide and oxygen sensors, moisture sensors, glucose sensors, A1C sensors, and ultrasonic sensors.

12. The system of claim 10, further including a DNA sensor for sensing and decoding a DNA sequence, wherein the sensor looks at specific DNA sequence for genetic markers associated with substance abuse susceptibility.

13. The system of claim 1, wherein the remote server further includes a remote server memory device, a remote server processing device, and a remote server communications device.
